(19) United States
(12) Patent Application Publication
(10) Pub. No.: US 2025/0111447 A1
(43) Pub. Date: Apr. 3, 2025

(54) INFORMATION PROCESSING APPARATUS, INFORMATION PROCESSING METHOD, AND PROGRAM

(71) Applicant: SONY GROUP CORPORATION, TOKYO (JP)

(72) Inventor: YASUHIDE HOSODA, TOKYO (JP)

(21) Appl. No.: 18/291,300

(22) PCT Filed: Mar. 3, 2022
(86) PCT No.: PCT/JP2022/009030

§ 371 Date: Jan. 23, 2024

(30) Foreign Application Priority Data
Aug. 6, 2021 (JP) 2021-129461

(51) Int. Cl. G06Q 50/00

(52) U.S. Cl. CPC G06Q 50/01

(57) ABSTRACT

The present technology relates to an information processing apparatus, an information processing method, and a program enabling appropriate communication to be achieved without imposing a psychological burden. In a case where an information processing apparatus according to one aspect of the present technology detects an action of a user estimated as thinking of another user, the information processing apparatus presents information related to an episode between the user and the another user to the another user, together with other information not related to the episode. The present technology can be applied to a system that promotes communication between users.

### TECHNICAL FIELD

The present technology relates to an information processing apparatus, an information processing method, and a program, and particularly relates to an information processing apparatus, an information processing method, and a program capable of achieving appropriate communication without imposing a psychological burden.

### BACKGROUND ART

Due to an influence of the novel coronavirus and the like, opportunities for communication are generally reduced. As a method for communication, a method using a social networking service (SNS) has been widely used, but there is a problem such as so-called SNS fatigue.

Patent Document 1 discloses an agent system that, in a case where it is detected that a user A feels lonely due to no contact from a lover or the like, shows a picture taken together with the user A to a user B who is the lover, and changes a character of the user B to a character that contacts the user A.

### CITATION LIST

### Patent Document

Patent Document 1: International Publication No. 2018/179745

### SUMMARY OF THE INVENTION

### Problems to be Solved by the Invention

The presentation of the picture as described above is obvious and causes a sense of mission that the user A needs to be contacted, and thus is burdensome in some situations of the user B. Furthermore, in a case where there is no contact from the user B even though obvious presentation of information has been made, the user A may be depressed.

As a tendency of communication using an SNS or the like, there is a tendency to avoid failure such as no contact from another person even though communication is actively performed.

The present technology has been made in view of such a situation, and enables appropriate communication to be achieved without imposing a psychological burden.

### Solutions to Problems

An information processing apparatus according to one aspect of the present technology includes: a detection unit configured to detect an action of a user estimated as thinking of another user; and a presentation unit configured to present information related to an episode between the user and the another user to the another user together with other information not related to the episode, in a case where an action of the user estimated as thinking of the another user is detected.

In one aspect of the present technology, in a case where an action of a user estimated as thinking of another user is detected, information related to an episode between the user and the another user is presented to the another user together with other information not related to the episode.

### BRIEF DESCRIPTION OF DRAWINGS

FIG. 1 is a view illustrating an example of information presentation in a communication system according to an embodiment of the present technology.

FIG. 2 is a view illustrating a relationship between information of direct indication and information of indirect indication.

FIG. 3 is a view illustrating an example of directly sending a message.

FIG. 4 is a diagram illustrating an example of a life log DB included in a communication management server.

FIG. 5 is a view illustrating an example of an episode of a user A.

FIG. 6 is a view illustrating an example of activation of a reminder action.

FIG. 7 is a view illustrating a presentation example of indirect information.

FIG. 8 is a view illustrating an example of association of a user B who has seen indirect information.

FIG. 9 is a block diagram illustrating a hardware configuration example of the communication management server.

FIG. 10 is a block diagram illustrating a functional configuration example of the communication management server.

FIG. 11 is a flowchart illustrating a series of processing of the communication management server.

FIG. 12 is a block diagram illustrating a configuration example of a client terminal.

FIG. 13 is a block diagram illustrating a functional configuration example of the client terminal.

FIG. 14 is a view illustrating an example of registration of an episode.

FIG. 15 is a view illustrating an example of an operation mode of a reminder action.

FIG. 16 is a view illustrating an example of a start timing of presentation of indirect information.

FIG. 17 is a view illustrating an example of association.

FIG. 18 is a view illustrating a presentation example of indirect information.

FIG. 19 is a view illustrating an example of a display screen of an episode of the user A.

FIG. 20 is a view illustrating an example of a friends list of the user A.

FIG. 21 is a view illustrating an example of a friends list of the user B.

FIG. 22 is a view illustrating an example of an episode of the user B.

FIG. 23 is a view illustrating an example of presentation of indirect information.

FIG. 24 is a view illustrating an example of information used for selection of indirect information.

FIG. 25 is a view illustrating an example of linkage of events.

FIG. 26 is a view illustrating an example of indirect information.

### MODE FOR CARRYING OUT THE INVENTION

Hereinafter, a mode for carrying out the present technology will be described. The description will be given in the following order.
1. Overview of the present technology
2. Specific example of series of processing
3. Configuration and operation of each device of communication system
4. Details of individual processing

### Overview of Present Technology

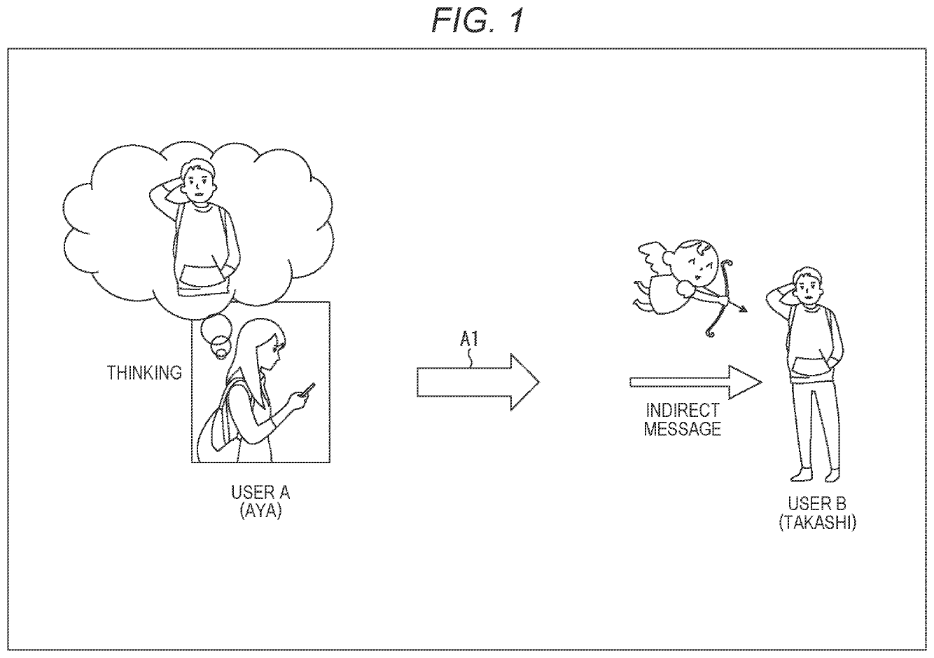

FIG. 1 is a view illustrating an example of information presentation in a communication system according to an embodiment of the present technology.

A user A (Aya) and a user B (Takashi) illustrated in FIG. 1 know each other. There are common episodes between the two persons, such as enjoying themselves together, eating together, traveling together, and the like.

In such a situation, as illustrated in a balloon of FIG. 1, it is assumed that the user A is thinking of the user B. The fact that the user A thinks of the user B is detected by the communication system, for example, by analyzing an action of the user A, and the like.

In a case where it is detected that the user A thinks of the user B, the communication system presents information serving as a trigger for recalling the user A, to the user B as indicated by a point of an arrow A1. The presentation of the information serving as a trigger for recalling the user A is performed, for example, by displaying information on a screen of a client terminal such as a smartphone used by the user B.

Here, the information presented to the user B as the information serving as a trigger for recalling the user A is not information directly indicating the user A but information indirectly indicating the user A.

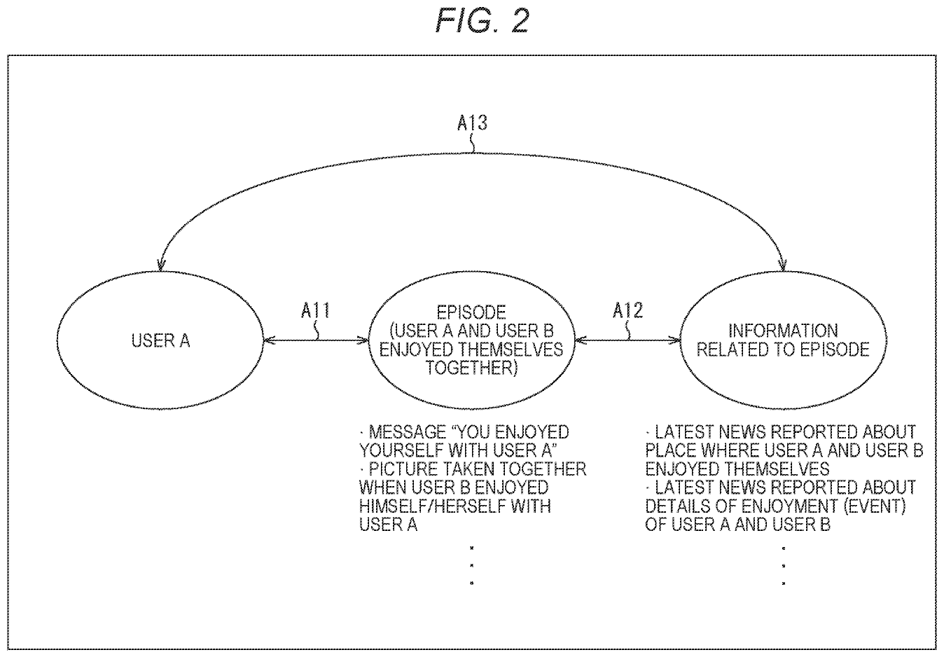

FIG. 2 is a diagram illustrating a relationship between information of direct indication and information of indirect indication.

As illustrated in a center of FIG. 2, in a case where there is an episode where the user A and the user B enjoyed themselves together, a message such as “you enjoyed yourself with the user A” is information directly indicating the user A. Furthermore, a picture taken together when the user A and the user B enjoyed themselves is also information directly indicating the user A.

These pieces of information are information directly indicating the user A for the user B as indicated by an arrow A11. Information such as information of an SNS posted by the user B and indicating that the user B has enjoyed himself/herself with the user A and a picture of the user A having no relation with the episode is also information directly indicating the user A.

On the other hand, as indicated by an arrow A12, information presented to the user B is information related to the episode in which the user A and the user B enjoyed themselves together. The information related to the episode also includes information further related to the information related to the episode. In the example of FIG. 2, the latest news reported about a place where the user A and the user B enjoyed themselves and the latest news reported about details of enjoyment of the user A and the user B are illustrated as the information related to the episode.

These pieces of information used as the information related to the episode are information not including information about the user A, and thus are information indirectly indicating the user A for the user B as indicated by an arrow A13.

Hereinafter, information serving as a trigger for recalling a certain person is referred to as “indirect information” in the sense of information indirectly indicating the person.

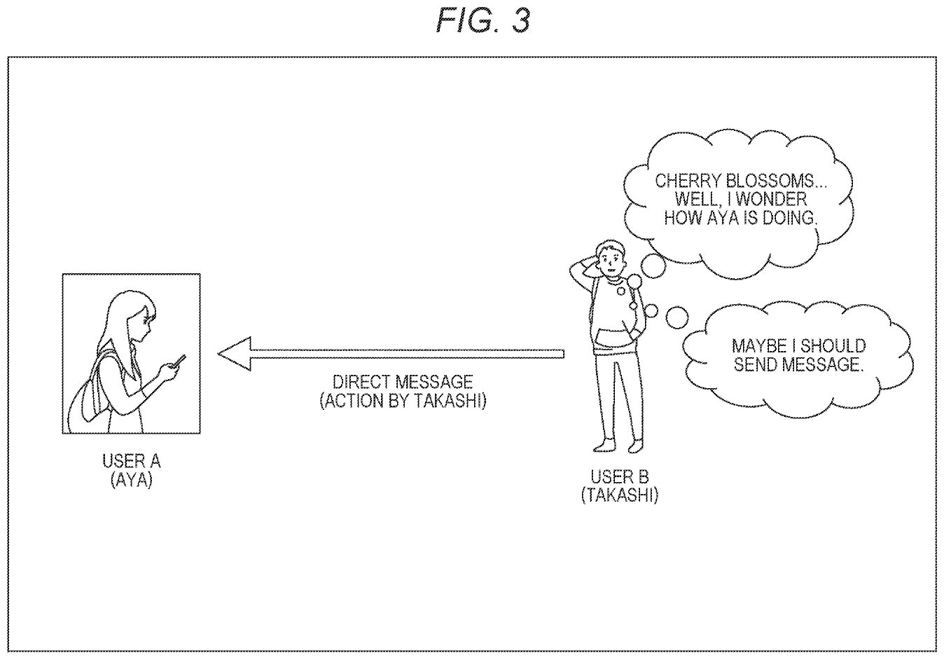

The user B who has viewed the indirect information presented by the communication system recalls the user A by associating from the indirect information, and takes an action such as making a phone call to the user A or sending an e-mail or an SNS message as illustrated in FIG. 3. The user A who has received the direct contact from the user B experiences a coincidental experience of receiving a contact from the user B while thinking of the user B.

As described above, in the communication system, fateful presentation, so to speak, is realized in which a certain person (user A) who is thinking of another person (user B) accidentally receives a contact from that another person. The communication system plays a role of a bridge between the user A and the user B.

The indirect information is not presented to the user B by an instruction of the user A who is thinking of the user B, but is automatically presented by the communication system without recognition by the user A. Even if there is no contact from the user B, the user A is not hurt by the fact.

In a case where the indirect information is presented to the user B in response to an instruction of the user A, when there is no contact from the user B, the user A is discouraged because there is no contact even though the user A has actively taken an action. Since the indirect information is automatically presented to the user B, it is possible to prevent the user A from having such a feeling.

Furthermore, the indirect information presented to the user B is not information directly indicating the user A but information indirectly indicating the user A. In a case where the user B has no feeling for the user A, the user B is merely not to recall the user A, and thus, the user B does not feel a burden even if the indirect information is presented.

In a case where the information directly indicating the user A is presented in response to an instruction of the user A, the user B who recalls the user A after seeing the presented information has a sense of mission in contacting the user A. In a case where the user B does not contact the user A even though the user B has seen the presented information, the user B has a sense of guilt similarly to a case where the user B leaves on read, as it is called. By automatically presenting the information indirectly indicating the user A, it is also possible to prevent the user B from feeling such a burden.

As described above, according to the communication system of FIG. 1, it is possible to realize fateful presentation in which a certain person thinking of another person accidentally receives a contact from that another person, without imposing a burden on anyone. The communication system of FIG. 1 can be said to be a system that is easy to use also for a person who is hesitant to actively take an action from himself/herself or a person who does not want to be hurt due to no contact from another person.

### Specific Example of Series of Processing

A communication management server that realizes fateful presentation is prepared in the communication system of FIG. 1.

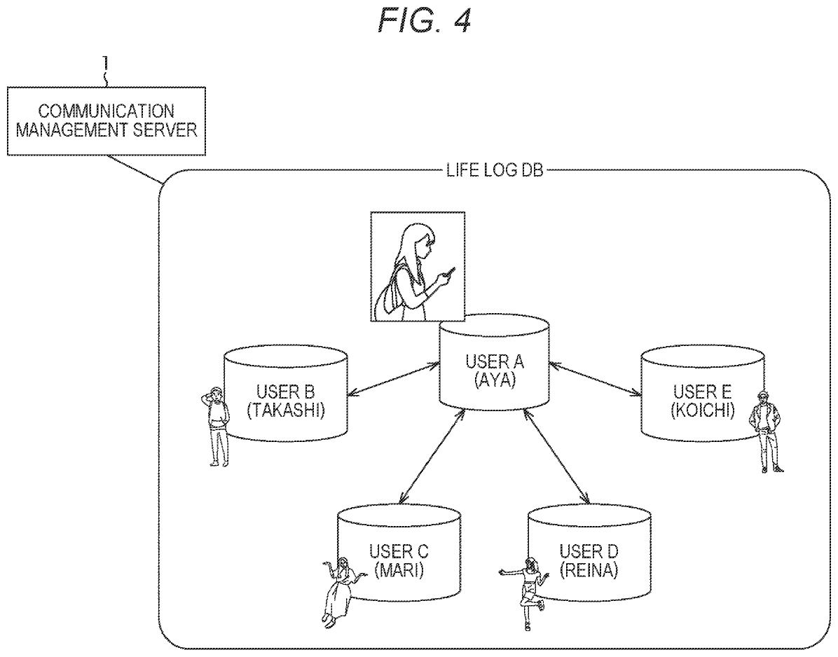

FIG. 4 is a diagram illustrating an example of a life log DB included in the communication management server.

A communication management server 1 includes a life log DB which is a data base (DB) in which a life log of a user is recorded. The life log includes information about episodes of the user with other users. The episodes include not only episodes about events but also episodes about actions taken by the user with other users, episodes about feelings for other users, and the like.

The life log DB is prepared for each user who uses the communication system. The life log DB illustrated in FIG. 4 is a database for the user A (Aya). In the example of FIG. 4, information about an episode of the user A with the user B (Takashi), information about an episode with a user C (Mari), information about an episode with a user D (Reina), and information about an episode with a user E (Koichi) are individually recorded in the life log DB of the user A. The user B, the user C, the user D, and the user E are acquaintances of the user A.

The episodes are registered by the user himself/herself, for example. The episodes with other users may be automatically registered by the communication management server 1 on the basis of an action history or the like of each of the user and other users.

A communication application, which is an application for using the communication system of FIG. 1, is installed in the client terminal of the user. Various types of processing including registration of an episode and presentation of indirect information are performed by cooperation between the communication application and the communication management server 1.

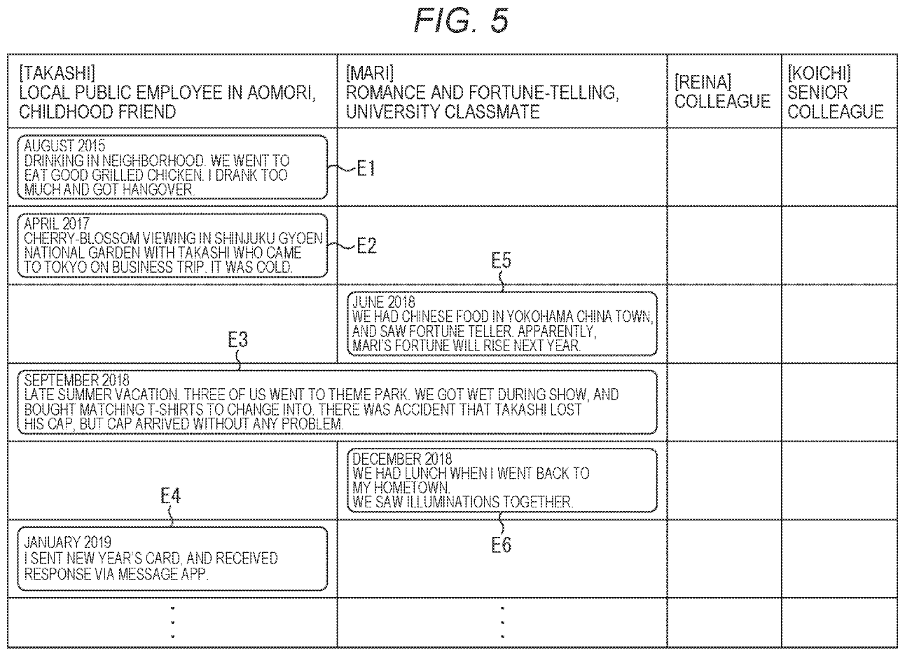

FIG. 5 is a view illustrating an example of episodes of the user A.

As illustrated in the first line of FIG. 5, attribute information of each user is also recorded in the life log DB. In the example of FIG. 5, the user B (Takashi) is a childhood friend of the user A, and currently works as a local public employee in Aomori. The user C (Mari) is a university classmate of the user A, and is interested in romance and fortune-telling. The user D (Reina) is a colleague in a company, and the user E (Koichi) is a senior colleague in the company.

Episodes E1 and E2 illustrated in FIG. 5 are episodes with the user B, and Episode E3 is an episode with the user B and the user C. In this manner, episodes involving three or more people are also appropriately recorded in the life log DB. Episode E4 is an episode with the user B, and Episodes E5 and E6 are episodes with the user C. The episode with the user D and the episode with the user E are also similarly recorded in the life log DB.

For example, Episode E1 is an episode of August 2015. An episode of when the user A went to eat grilled chicken together with the user B is recorded as Episode E1.

Furthermore, Episode E2 is an episode of April 2017. An episode of when the user A visited Shinjuku Gyoen National Garden for cherry-blossom viewing together when the user B came to Tokyo on a business trip from Aomori is recorded as Episode E2.

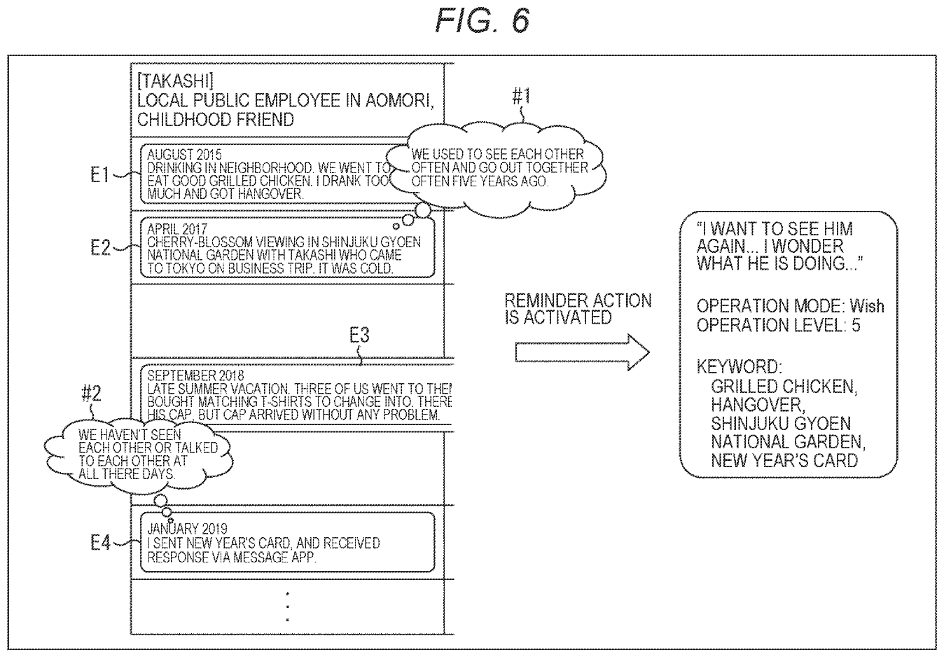

In a case where such an episode with each user is recorded as an episode of the user A, when it is detected that the user A thinks of the user B as illustrated in balloons #1 and #2 in FIG. 6, a “reminder action” is activated as indicated by an arrow.

The reminder action is an operation of the communication system of presenting, to the user B, indirect information serving as a trigger for recalling the user A. In response to the activation of the reminder action, the presentation of the indirect information is initiated.

In the example of FIG. 6, the reminder action is activated in response to detection of a state of the user A recalling details of Episode E2 and being nostalgic about outing with the user B, or recalling details of Episode E4 and thinking that the user A has not seen the user B recently. It can be said that the state of the user A recalling details of Episode E2 and being nostalgic about outing with the user B, or recalling details of Episode E4 and thinking that the user A has not seen the user B recently is a state estimated as thinking of the user B. The state of the user A is detected on the basis of the user A inputting a feeling for each episode on the screen of the communication application, the user A viewing a picture related to the episode, and the like.

Furthermore, in the example of FIG. 6, the reminder action is activated with an operation mode set to “Wish mode” and an operation level set to “5”. A plurality of types of modes is prepared as the operation mode of the reminder action. The “Wish mode” is an operation mode to be selected when the user A is desired to see the user B.

For example, details of the reminder action such as contents of the indirect information to be presented to the user B and a frequency of presentation of the indirect information are determined in accordance with the operation mode and the operation level. The operation mode and the operation level are specified by the communication system, for example, by analyzing feelings for each episode.

In the example of FIG. 6, “grilled chicken”, “hangover”, “Shinjuku Gyoen National Garden”, and “New Year's card” are selected as keywords. The keyword is selected on the basis of the contents of the episode with the user B. For example, “grilled chicken” is a keyword selected on the basis of Episode E1, and “Shinjuku Gyoen National Garden” is a keyword selected on the basis of Episode E2. These keywords are used to select indirect information to be presented to the user B.

Keywords selected on the basis of contents of Episode E2 and Episode E4, which are episodes for which the user B inputs impressions, may be used for selection of indirect information.

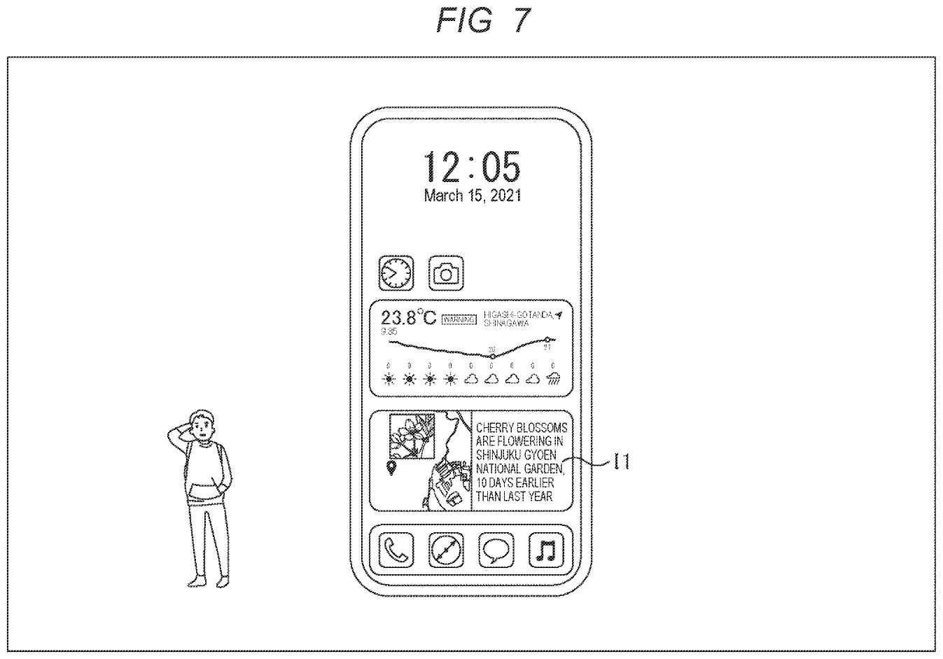

FIG. 7 is a view illustrating a presentation example of indirect information.

In a case where the reminder action is activated in the state illustrated in FIG. 6, indirect information I1 is displayed on a screen of the client terminal of the user B as illustrated in FIG. 7. The indirect information I1 is news about flowering of cherry blossoms in Shinjuku Gyoen National Garden. That is, the indirect information I1 is recent news related to Episode E2 and selected by, for example, searching for news on the Internet on the basis of the keyword of “Shinjuku Gyoen National Garden”. The news about the flowering of cherry blossoms in Shinjuku Gyoen National Garden is information regarding an event that has occurred at a timing later than a timing at which the event involved in Episode E2 has occurred.

The indirect information I1 is displayed in the same format as a display format of information of other applications such as a weather forecast application so that the user B does not know that the indirect information I1 is presented by the communication application. The presentation of the indirect information I1 is performed so as to be casually presented together with other information not related to the episode.

The user B sees the news about flowering of cherry blossoms in Shinjuku Gyoen National Garden in a natural flow together with the information of other applications, without awareness of the existence of the communication application. The indirect information may be presented not by screen display but by sound output.

Here, when the user B went to Tokyo on a business trip in April 2017, the user B visited Shinjuku Gyoen National Garden together with the user A for cherry-blossom viewing (FIG. 6). The two persons have not been in contact since exchange on New Year's card and the like in 2019.

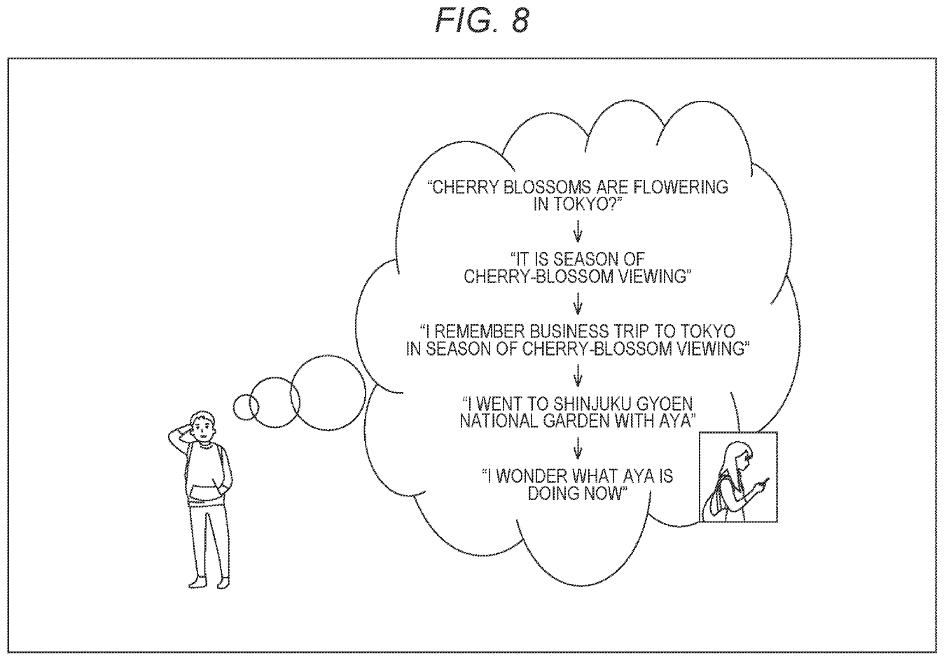

FIG. 8 is a view illustrating an example of association of the user B who has seen the indirect information I1.

As illustrated in FIG. 8, the user B who has seen the indirect information I1 and knows flowering of the cherry blossoms in Tokyo recalls the user A (Aya) by associating from the flowering of cherry blossoms in Tokyo as a starting point. The episode of cherry-blossom viewing in Shinjuku Gyoen National Garden is an episode that has also left an impression on the user B.

The fact that the episode of cherry-blossom viewing in Shinjuku Gyoen National Garden has also left an impression on the user B is specified on the basis of, for example, the episode recorded in the life log DB for the user B. The above-described keyword used for selection of indirect information is appropriately selected on the basis of the episode recorded in the life log DB for the user B.

With the presentation of the indirect information I1 as a trigger, the user B recalls the user A. The user B who thinks of the user A contacts the user A by making a phone call or sending an e-mail or an SNS message. Continuation of the episode of two persons begins.

The fateful presentation by the communication system is realized as described above.

### <<Configuration and Operation of Each Device of Communication System>>

### <Configuration and Operation of Communication Management Server>

### Configuration of Communication Management Server

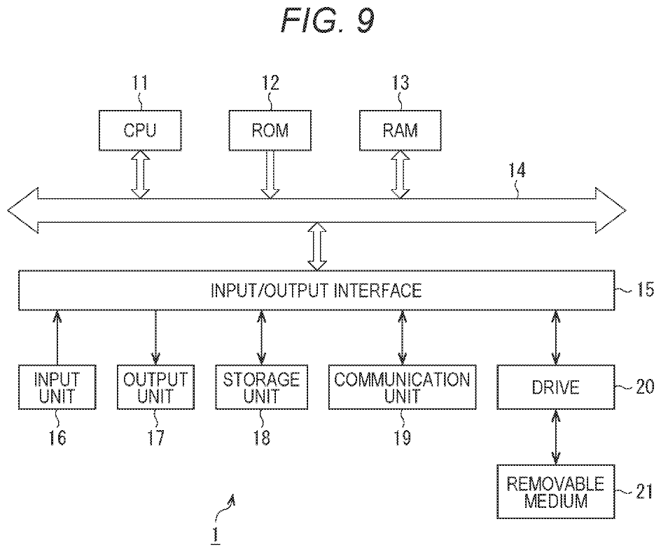

FIG. 9 is a block diagram illustrating a hardware configuration example of the communication management server 1.

As illustrated in FIG. 9, the communication management server 1 includes a computer. The communication management server 1 may be implemented by a plurality of computers.

A central processing unit (CPU) 11, a read only memory (ROM) 12, and a random access memory (RAM) 13 are mutually connected by a bus 14.

An input/output interface 15 is further connected to the bus 14. An input unit 16 including a keyboard, a mouse, and the like, and an output unit 17 including a display, a speaker, and the like are connected to the input/output interface 15.

Furthermore, a storage unit 18, a communication unit 19, and a drive 20 are connected to the input/output interface 15.

The storage unit 18 includes a hard disk, a nonvolatile memory, or the like. The storage unit 18 stores various types of information such as a program executed by the CPU 11 and information regarding each user. The life log DB of FIG. 4 is constructed in the storage unit 18.

The communication unit 19 includes a network interface and the like. The communication unit 19 communicates with various devices for implementing the communication system, such as the client terminal owned by each user, via the Internet.

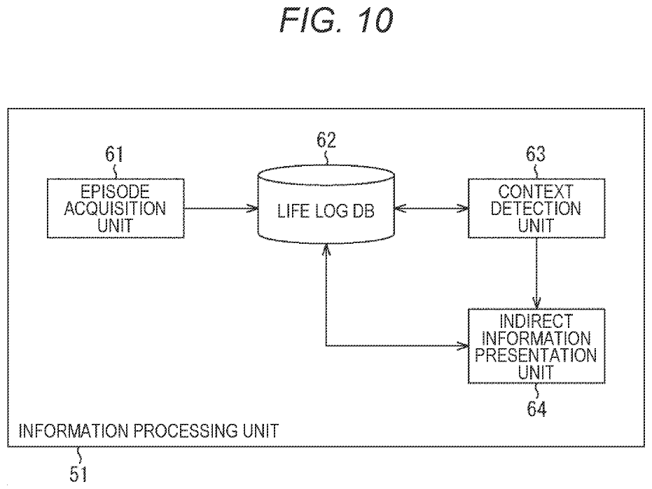

FIG. 10 is a block diagram illustrating a functional configuration example of the communication management server 1.

In the communication management server 1, the CPU 11 in FIG. 9 executes a predetermined program to implement an information processing unit 51. The information processing unit 51 includes an episode acquisition unit 61, a life log DB 62, a context detection unit 63, and an indirect information presentation unit 64.

The episode acquisition unit 61 acquires an episode of each user. For example, the episode acquisition unit 61 acquires an episode directly input by the user on a screen of the communication application. Furthermore, the episode acquisition unit 61 acquires an episode by analyzing contents posted on a site of an SNS by each user or analyzing an e-mail or a message of an SNS sent by each user to another user.

The episode acquisition unit 61 stores information about the episode of each user in a folder prepared for each of other users appearing in the episode, and records the information in the life log DB 62. For example, episodes between the user A and the user B, episodes between the user A and the user C, and episodes between the user A and the user D included in the episodes of the user A are individually recorded in different folders.

The context detection unit 63 detects a context of the user. The context detected by the context detection unit 63 includes that the user is taking an action estimated as thinking of another user. The context of the user is detected, for example, by analyzing an input content by operating a screen of the communication application or by analyzing an action of the user performed on the client terminal by the user, such as viewing an old picture. Information indicating contents of a user's operation, sensor data obtained by measuring biological reaction of the user, and the like are transmitted from the client terminal.

In the detection of the context, the episodes recorded in the life log DB 62 are appropriately referred to. For example, in a case where biological reaction of the user A when the user A is viewing the episode with the user B shows reaction of being nostalgic about the past, the user A is detected to be thinking of the user B. An inference model generated by machine learning may be prepared in advance in the context detection unit 63 and used for detecting the context.

The fact that the user A thinks of the user B may be detected on the basis of a soliloquy of the user A such as “I want to see Takashi” acquired in the client terminal. The fact that the user A thinks of the user B is detected on the basis of at least any of contents input by the user and a situation of the user.

The indirect information presentation unit 64 activates the reminder action on the basis of the context detected by the context detection unit 63. In a case where the reminder action is activated, the indirect information presentation unit 64 refers to episodes recorded in the life log DB 62, for example, and selects indirect information.

The indirect information presentation unit 64 causes the client terminal to output the indirect information, to present the indirect information to the user. The indirect information acquired by the indirect information presentation unit 64 may be transmitted to the client terminal and presented in the client terminal, or information such as a URL from which the indirect information is acquired may be transmitted to the client terminal and used for presentation in the client terminal.

### Operation of Communication Management Server

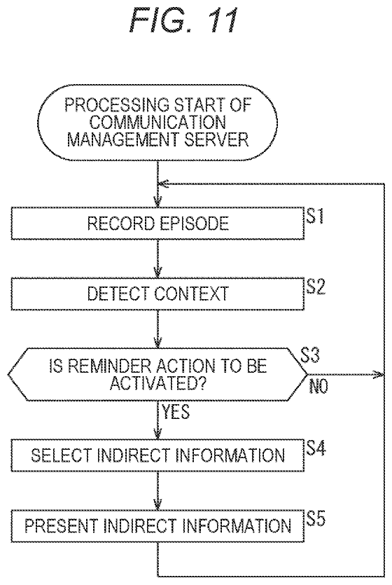

With reference to a flowchart of FIG. 11, a series of processing of the communication management server 1 will be described. Processing of each step is appropriately performed in parallel with other processing or before and after other processing.

In step S1, the episode acquisition unit 61 acquires information about an episode of each user, and records the information in the life log DB 62.

In step S2, the context detection unit 63 refers to the episode recorded in the life log DB 62, for example, and detects a context of the user.

In step S3, the indirect information presentation unit 64 determines whether or not to activate the reminder action on the basis of the context of the user. In a case where it is determined in step S3 that the reminder action is not to be activated, the processing returns to step S1, and the above-described processing is repeated.

In a case where it is determined in step S3 that the reminder action is to be activated, in step S4, the indirect information presentation unit 64 refers to the episode recorded in the life log DB 62 and selects indirect information. For example, a keyword for the episode is selected, and the indirect information is selected on the basis of the keyword.

In step S5, the indirect information presentation unit 64 causes the client terminal to output the selected indirect information, to present the selected indirect information to the user. After the indirect information is presented, the processing returns to step S1, and the above-described processing is repeated.

### <Configuration of Client Terminal>

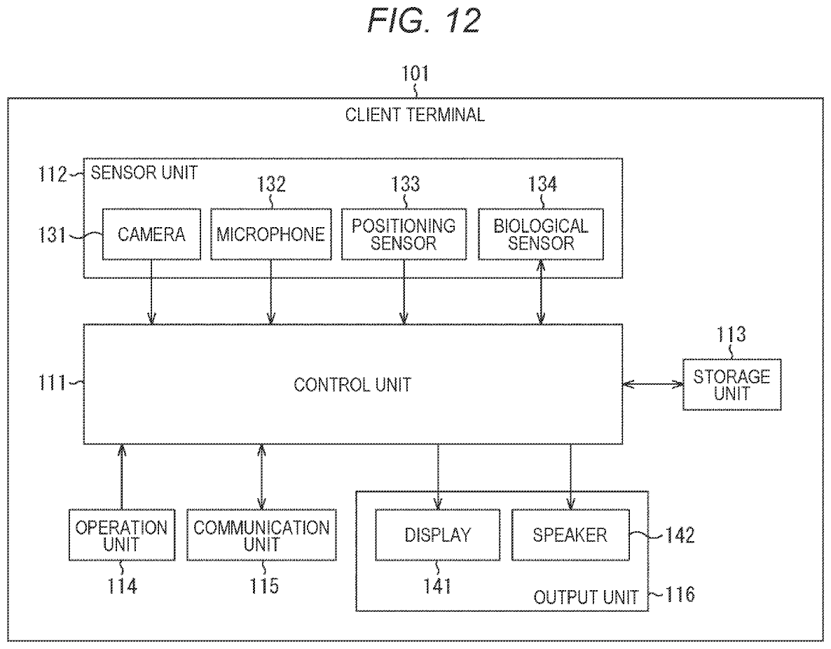

FIG. 12 is a block diagram illustrating a configuration example of a client terminal 101.

The client terminal 101 is configured by connecting a sensor unit 112, a storage unit 113, an operation unit 114, a communication unit 115, and an output unit 116 to a control unit 111. The client terminal 101 is an information processing terminal such as a smartphone constituting the communication system.

The control unit 111 includes a CPU, a ROM, a RAM, and the like. The control unit 111 executes a predetermined program by using the CPU, and controls the entire operation of the client terminal 101.

The sensor unit 112 includes a camera 131, a microphone 132, a positioning sensor 133, and a biological sensor 134.

The camera 131 captures an image of the surroundings of the user having the client terminal 101, and outputs an image obtained by image-capturing to the control unit 111. The image captured by the camera 131 may be a still image or a moving image.

The microphone 132 detects various types of sound such as user's voice and surrounding environment sound, and outputs the sound to the control unit 111.

The positioning sensor 133 includes a GPS sensor or the like. The positioning sensor 133 detects a position of the client terminal 101, and outputs the position to the control unit 111.

The biological sensor 134 includes a body temperature sensor, a heart rate sensor, and the like. A sensor that detects electroencephalogram such as alpha waves or beta waves may be included in the biological sensor 134. The biological sensor 134 detects biological data of the user such as a body temperature, a heart rate, and brain waves, and outputs the biological data to the control unit 111.

The storage unit 113 includes a flash memory or the like. The storage unit 113 stores various types of data such as the communication application.

The operation unit 114 includes a touch panel provided on a display 141, a button provided at a predetermined position of a housing of the client terminal 101, and the like. The operation unit 114 detects a user's operation, and outputs information indicating contents of the operation to the control unit 111.

The communication unit 115 is an interface for short-distance wireless communication such as Bluetooth (registered trademark) or a wireless LAN, and an interface for wireless communication using a mobile communication system (WAN) such as 4G or 5G. The communication unit 115 communicates with an external device such as the communication management server 1.

The output unit 116 includes the display 141 and a speaker 142. The display 141 displays various types of information under the control of the control unit 111. The speaker 142 outputs various types of sound and sound effects under the control of the control unit 111.

Note that the configuration of the client terminal 101 as described above is appropriately changed in accordance with a type of the client terminal 101, such as a smartphone, a smart watch, or a head mounted display (HMD). According to the type of the client terminal 101, some of the configurations illustrated in FIG. 12 may not be provided, or other configurations not illustrated in FIG. 12 may be provided.

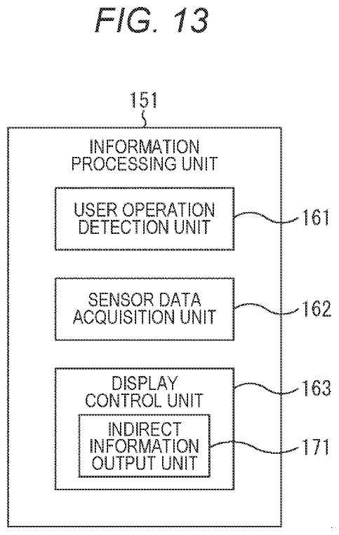

FIG. 13 is a block diagram illustrating a functional configuration example of the client terminal 101.

In the control unit 111, a program such as the communication application is executed to implement an information processing unit 151. The information processing unit 151 includes a user operation detection unit 161, a sensor data acquisition unit 162, and a display control unit 163.

The user operation detection unit 161 detects various user's operations such as an operation on a screen of the communication application. The user operation detection unit 161 transmits information indicating contents of the user's operations to the communication management server 1.

The sensor data acquisition unit 162 acquires sensor data supplied from the sensor unit 112. Sensor data including an image captured by the camera 131, sound detected by the microphone 132, a position of the user detected by the positioning sensor 133, and biometric data detected by the biological sensor 134 is supplied from the sensor unit 112. Data detected by other sensors such as data detected by a gyro sensor or an acceleration sensor and data detected by a temperature sensor may be included in the sensor data.

The sensor data acquisition unit 162 communicates with the communication management server 1 by controlling the communication unit 115, and transmits the sensor data supplied from the sensor unit 112 to the communication management server 1.

The context of the user may be detected on the client terminal 101 side instead of on the communication management server 1 side. In this case, a processing unit having a function similar to that of the context detection unit 63 (FIG. 10) is provided in the client terminal 101. Information about the context of the user detected in the client terminal 101 on the basis of the sensor data acquired by the sensor data acquisition unit 162 is transmitted from the client terminal 101 to the communication management server 1 and used for activation of the reminder action or the like.

In this manner, at least a part of the processing unit of the communication management server 1 can be provided in the client terminal 101. Furthermore, at least a part of the processing unit of the client terminal 101 can be provided in the communication management server 1.

The display control unit 163 controls display of various screens on the display 141, such as a screen of the communication application. The display control unit 163 includes an indirect information output unit 171.

The indirect information output unit 171 communicates with the communication management server 1 by controlling the communication unit 115, acquires indirect information under the control of the communication management server 1, and presents the indirect information to the user.

### Details of Individual Processing

Here, details of processing in the communication system will be described.

### Another Example of Indirect Information

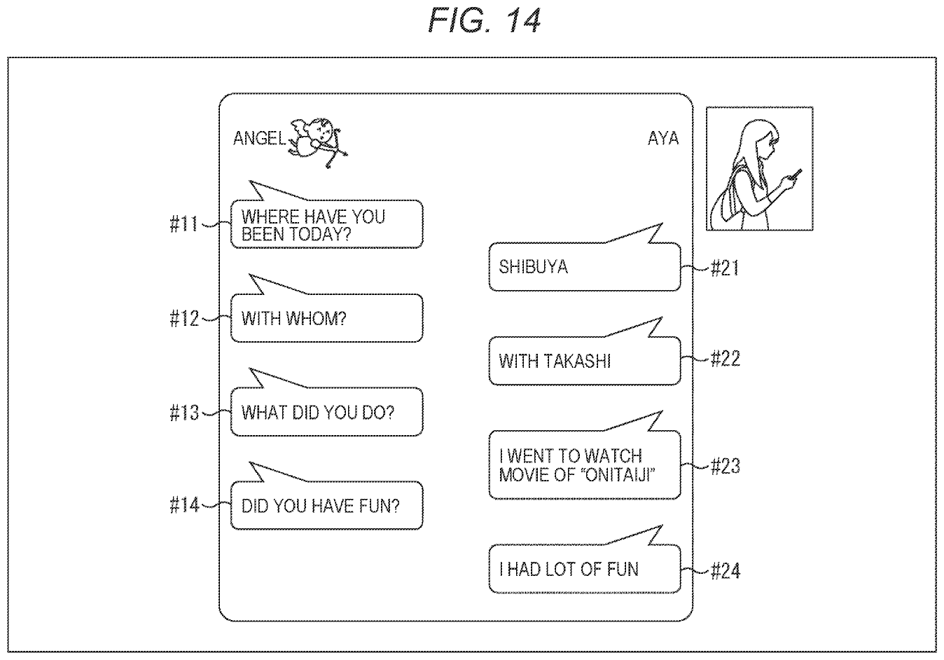

FIG. 14 is a view illustrating an example of registration of an episode.

As illustrated in FIG. 14, registration of the episode is performed, for example, in a conversation form with an angel that is a virtual character. A screen illustrated in FIG. 14 is a screen displayed on the client terminal of the user A (Aya) by the communication application.

The episode is registered by the user A answering to an inquiry by the angel. Comments in balloons #11 to #14 on the left side are comments of the inquiry by the angel, and comments in balloons #21 to #24 on the right side are comments of the answer of the user A. The conversation with the angel may be performed by text or may be performed by voice.

As a result of the conversation as illustrated in FIG. 14 being held, an episode regarding “we went to watch the movie of “Onitaiji (ogre extermination)” in Shibuya” is registered as an episode with the user B (Takashi). Such registration of the episode by using an UI in the conversation form is performed by the episode acquisition unit 61 (FIG. 10).

The comment of the user A in Balloon #24 is a comment indicating contents in which the episode has left an impression on the user A and the user A has a good impression on the user B. For example, the context detection unit 63 analyzes contents of the comment and detects contents of thought by the user A.

A date and time included in the episode and information such as “Shibuya” as a place may be automatically set on the basis of information detected by a GPS sensor or the like of the client terminal, without depending on an input of the user A. Furthermore, the contents of thought by the user A may be automatically detected on the basis of biological reaction or the like detected by the biological sensor of the client terminal, without depending on an input of the user A.

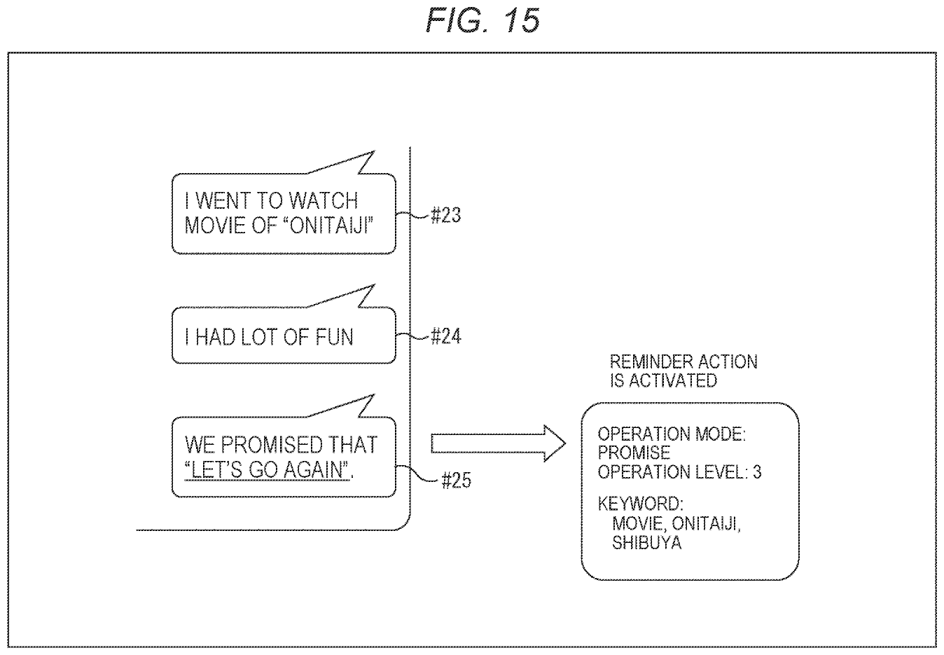

In a case where a comment indicated in Balloon #25 of FIG. 15 and having a content indicating a promise to go again is input following the comment of Balloon #24, a context indicating that the user A thinks of the user B is detected by the context detection unit 63, and the reminder action is activated.

The operation mode of the reminder action is a promise mode. The promise mode is an operation mode in which presentation of indirect information is started after a lapse of a certain period or more. For example, the presentation of the indirect information is started after a lapse of a period such as three years in which the persons in question are considered to forget the promise. Note that “movie”, “Onitaiji”, and “Shibuya” are selected as keywords. As described above, as the operation mode of the reminder action, an operation mode in which the presentation of the indirect information is immediately started and an operation mode in which the presentation of the indirect information is started when a predetermined condition such as a lapse of a certain period is satisfied are prepared.

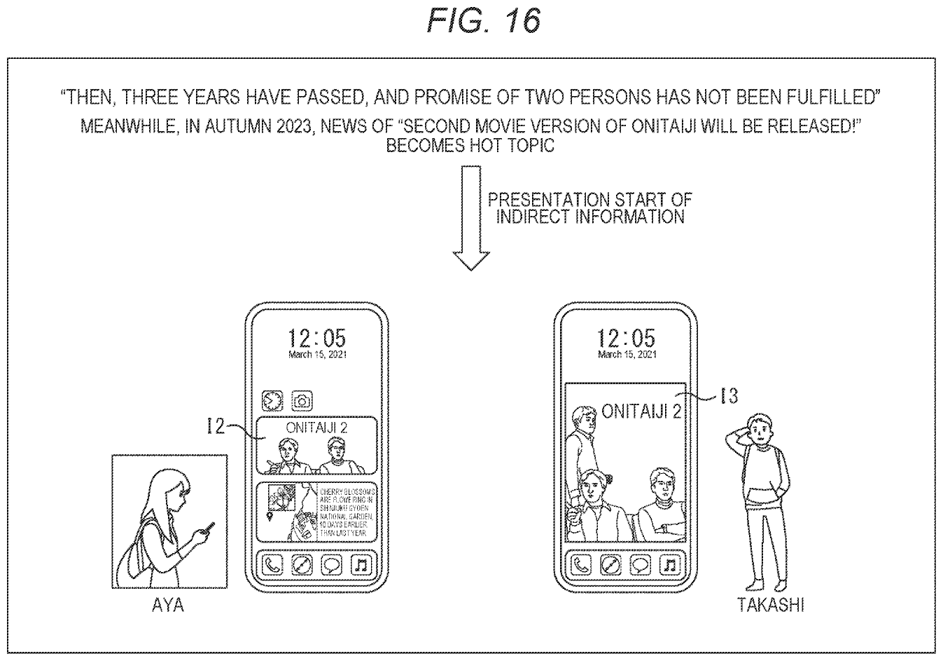

If three years have passed since the activation of the reminder action in the promise mode and the promise of the two persons has not been fulfilled during that time, the presentation of the indirect information is started for each of the user A and the user B as illustrated in FIG. 16. The fact that the promise of the two persons is not fulfilled is specified on the basis of the episode of each of the user A and the user B.

For example, in a case where “Onitaiji 2”, which is a sequel to “Onitaiji”, is a hot topic, information regarding the release of a movie of “Onitaiji 2” selected on the basis of the keyword of “Onitaiji” is presented as the indirect information to each of the user A and the user B. The indirect information presentation unit 64 presents indirect information to each of the user A and the user B.

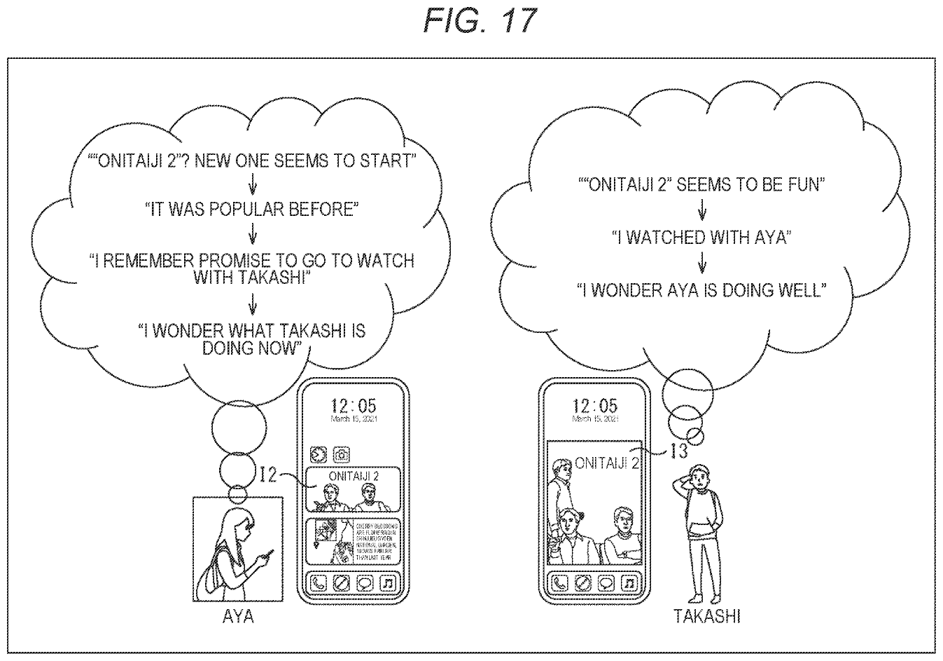

In FIG. 16, each of indirect information I2 displayed on the client terminal of the user A and indirect information 13 displayed on the client terminal of the user B is information regarding the release of the movie of “Onitaiji 2”. The two persons who have seen the information regarding the release of the movie of “Onitaiji 2” each recall the other person as illustrated in FIG. 17. A contact from either of the two persons triggers achievement of the promise of the two persons. In this manner, indirect information can be presented to two persons.

For example, in a case where the indirect information I2 and 13 is selected, detailed information regarding the release of the movie of “Onitaiji 2” is displayed. Checking of the detailed information is detected by the indirect information presentation unit 64, for example. As either one of the users checks the detailed information more, it is determined that the user has a greater feeling for another user. A degree of feeling toward the another user is determined on the basis of the number of times of checking the detailed information, a period of time of checking the detailed information, and the like.

In a case where the user A has viewed the detailed information regarding the release of the movie of “Onitaiji 2” many times, it is determined that the user A has a large feeling for the user B, and the indirect information is repeatedly presented to the user B.

The indirect information is presented to the user B a plurality of times, for example, until the user B contacts the user A, while using other information related to the release of the movie of “Onitaiji 2” or gradually increasing a display size. The number of pieces of information regarding the release of the movie of “Onitaiji 2” displayed on the same screen may be gradually increased every time the presentation of the indirect information is repeated.

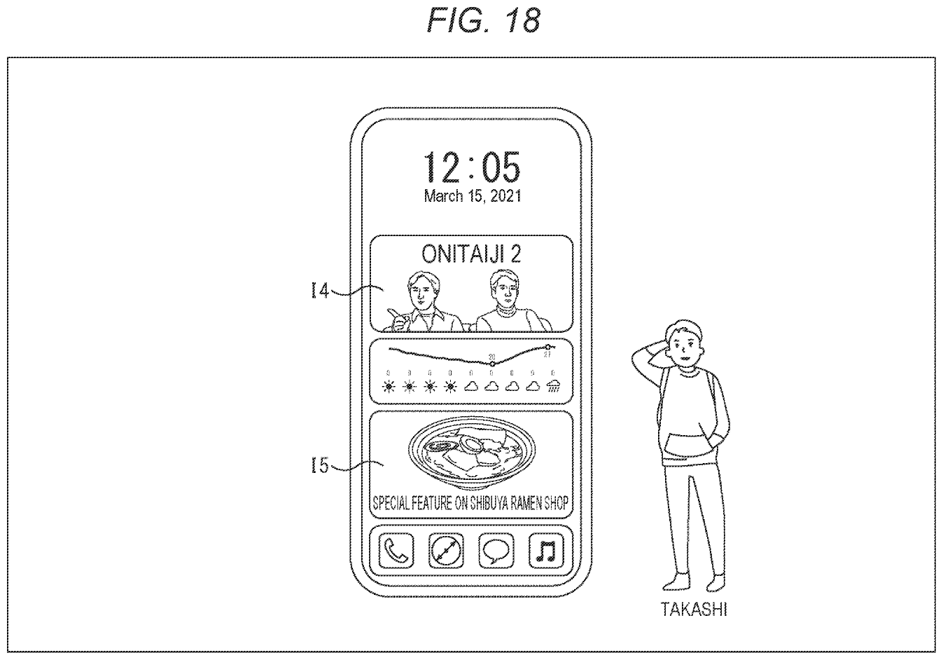

Furthermore, as illustrated in FIG. 18, indirect information selected on the basis of different keywords related to the same episode may be displayed on the same screen, together with information regarding release of the movie of “Onitaiji 2”. Indirect information I4 illustrated in FIG. 18 is information regarding the release of the movie of “Onitaiji 2”. Whereas, indirect information 15 is information about a special feature on ramen shops in Shibuya selected on the basis of the keyword “Shibuya”. As described above, the keyword “Onitaiji” and the keyword “Shibuya” are keywords related to the same episode of when “we went to watch the movie of “Onitaiji” in Shibuya”.

From a relationship between the movie “Onitaiji” and the place “Shibuya”, it is possible to remind the user B of the user A more strongly.

In a case of presenting the indirect information to two persons, the user A and the user B, the indirect information may be selected on the basis of the same episode of when “we went to watch the movie of “Onitaiji” in Shibuya”, or the indirect information may be selected on the basis of different episodes.

### <Friends List>

### Example of Using Evaluation of Self

Each user may be able to evaluate an episode with another user. For example, activation of the reminder action is controlled on the basis of a height of an evaluation for the episode. Furthermore, information related to highly evaluated episodes is used as the indirect information.

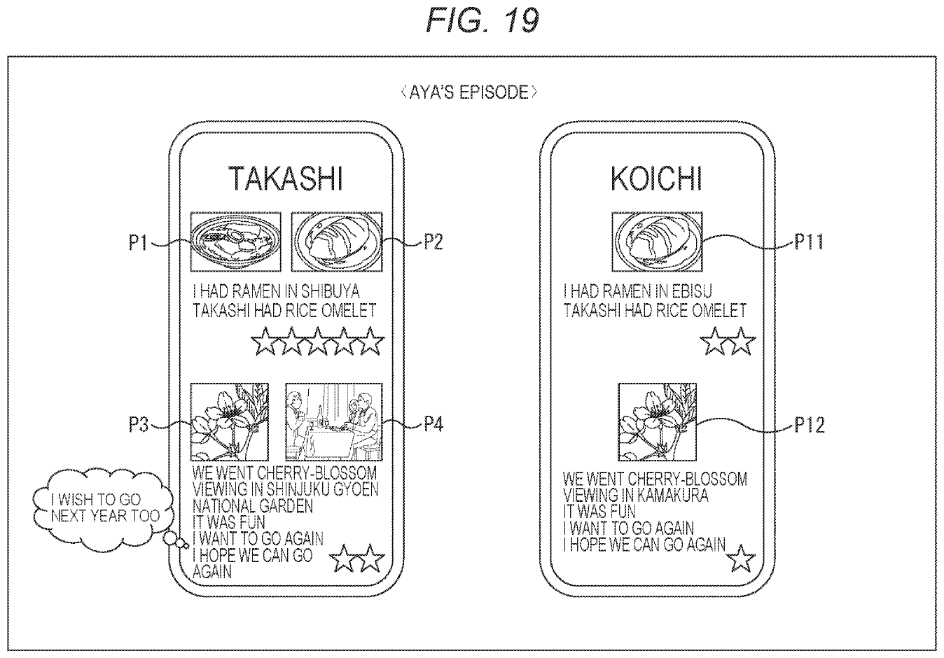

FIG. 19 is a view illustrating an example of a display screen of an episode.

Screens illustrated in FIG. 19 are screens displayed on the client terminal of the user A (Aya). The screen illustrated on the left side of FIG. 19 is a display screen of an episode with the user B (Takashi), and the screen illustrated on the right side is a display screen of an episode with the user E (Koichi).

Such an episode may be registered in accordance with exchange with the virtual character as described above, or the user A may register the episode by himself/herself. In this example, an image (picture) related to the episode is registered together with text representing contents of the episode.

In the episode with the user B illustrated on the left side, pictures P1 and P2 are pictures obtained by image-capturing when the user A had a meal with the user B. Furthermore, pictures P3 and P4 are pictures obtained by image-capturing when the user A went cherry-blossom viewing with the user B. An evaluation with five stars is set for the episode at the time of having a meal, and an evaluation with two stars is set for the episode at the time of cherry-blossom viewing. The evaluation may be set by the user A, or may be set on the system side in response to registration of an impression as shown in a balloon.

In the episode with the user E illustrated on the right side, a picture P11 is a picture obtained by image-capturing when the user A had a meal with the user E. Furthermore, a picture P12 is a picture obtained by image-capturing when the user A went cherry-blossom viewing with the user E. An evaluation with two stars is set for the episode at the time of having a meal, and an evaluation with one star is set for the episode at the time of cherry-blossom viewing.

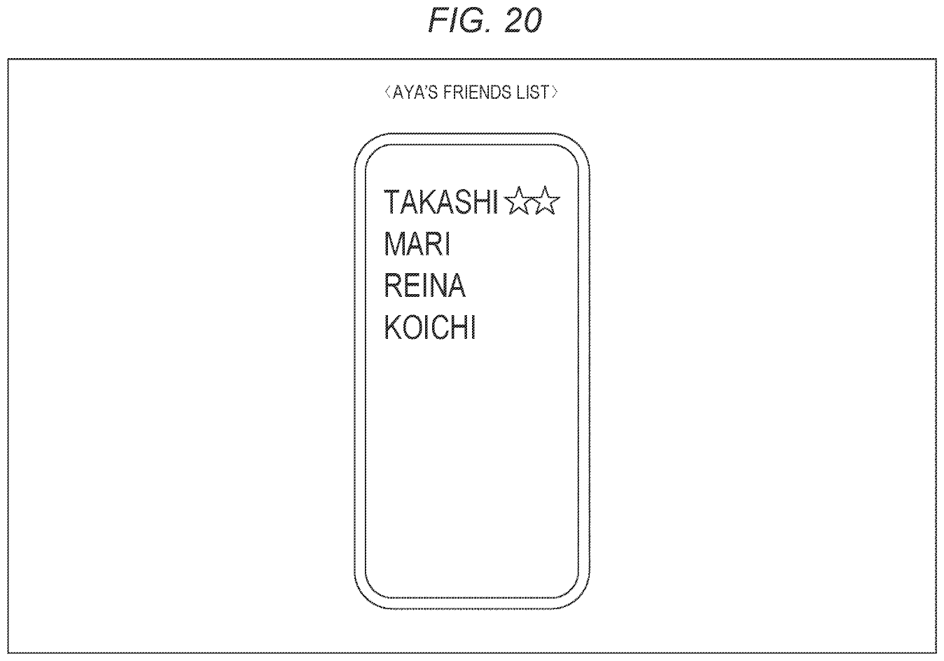

In a case where the user A sets such an evaluation for the episode with the user B and the episode with the user C, an evaluation higher than that of the user E is set for the user B as illustrated in FIG. 20. Also in the friends list in FIG. 20, the evaluation for each user is displayed by star marks. It may be considered that a partner whom the user A wants to contact is the user B rather than the user E.

In such a state, in a case where it is detected that the user A thinks of two persons, the user B and the user E, the reminder action for the user B which is the user with the high evaluation is activated. As a result, indirect information serving as a trigger for recalling the user A is presented to the user B whom the user A wants to contact more strongly.

Furthermore, a manner of presenting the indirect information may be changed according to a degree of the evaluation. For example, in a case where the evaluation for the user B is five stars, the indirect information is presented such that a possibility of recalling the user A becomes higher than that in a case where the evaluation is two stars. The possibility of recalling the user A is controlled by the number of times of presentation of the indirect information, the number of pieces and a size of the indirect information displayed on the same screen, contents of the indirect information, and the like. Controlling the possibility of the user B recalling the user A by changing the contents of the indirect information will be described later.

The evaluation of each user as illustrated in FIG. 20 may be set by the user A himself/herself. Furthermore, the user A may set a user for which activation of the reminder action is prohibited. In a case where the user E has been set as the user for which activation of the reminder action is prohibited, the indirect information reminding the user A is not presented to the user E.

In this manner, in accordance with his/her preference, each user may be able to set to facilitate activation of the reminder action for a certain user or to prohibit activation of the reminder action for a certain user.

### Example of Using Evaluation of Another Person

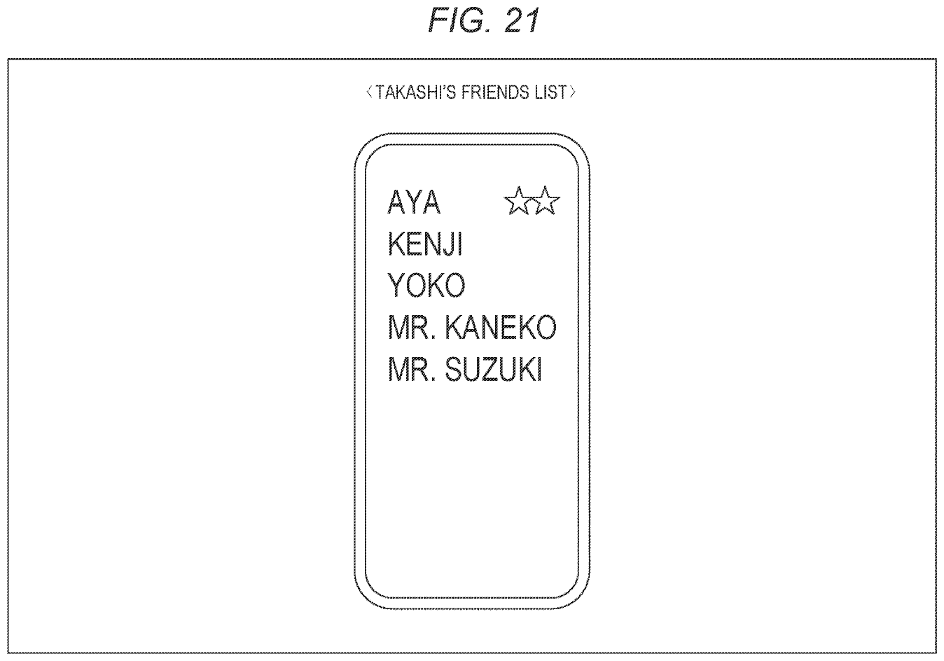

FIG. 21 is a view illustrating another example of the friends list.

The friends list illustrated in FIG. 21 is a friends list of the user B (Takashi) displayed on the client terminal of the user B. In the example of FIG. 21, a high evaluation is set for the user A (Aya) among friends of the user B. The evaluation of the user B is also set according to an operation of the user B or automatically set by the system side, for example.

As described above, in a case where the user A gives a high evaluation to the user B, a situation where the user B gives a high evaluation to the user A as illustrated in FIG. 21 is a so-called mutual love situation.

The activation of the reminder action for the user B in a case where the user A is thinking of the user B may be performed in a case where the user A is in the mutual love situation as described above. As a result, it is possible to increase the possibility that the user B who recalls the user A after seeing the indirect information contacts the user A. Furthermore, it is possible to prevent the indirect information serving as a trigger for recalling the user A from being presented to a user who is unlikely to recall the user A even after seeing the indirect information.

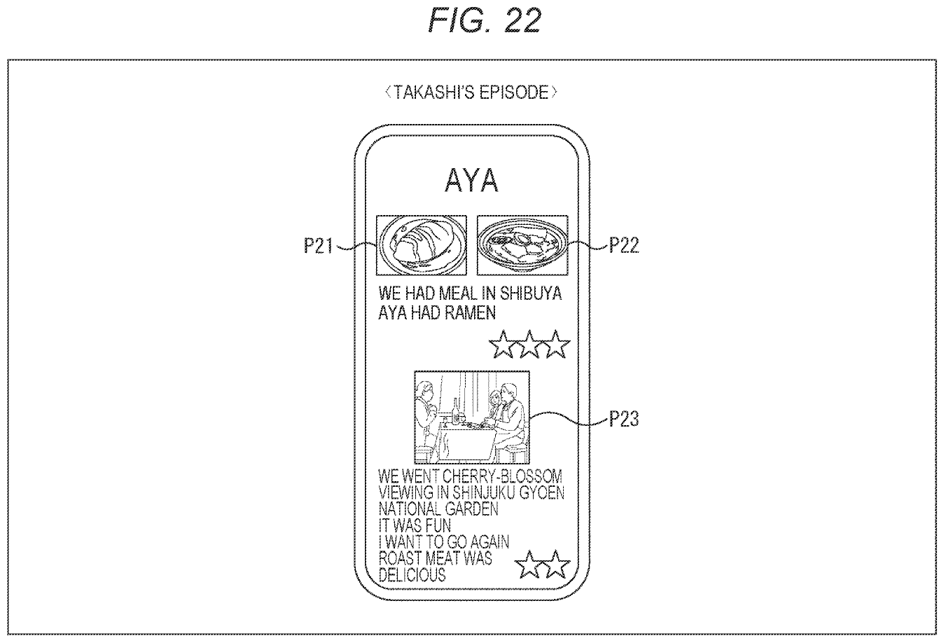

FIG. 22 is a view illustrating an example of an episode of the user B.

In the episode of the user B with the user A, pictures P21 and P22 are pictures obtained by image-capturing when the user B had a meal with the user A in Shibuya. Furthermore, a picture P23 is a picture obtained by image-capturing when the user B went cherry-blossom viewing with the user A. An evaluation with three stars is set for the episode at the time of having a meal, and an evaluation with two stars is set for the episode at the time of cherry-blossom viewing.

Among the episodes with the user A, it may be considered that the episode at the time of having a meal in Shibuya is more highly evaluated and has left a strong impression on the user B than the episode at the time of cherry-blossom viewing.

In this case, as the indirect information presented to the user B in the reminder action activated by the user A thinking of the user B, information related to the episode at the time of having a meal, which is considered to have left a strong impression on the user B, is used. For example, information such as “special feature on Shibuya ramen shop” (FIG. 18) selected on the basis of keywords “Shibuya” and “ramen” is presented to the user B as indirect information.

In this manner, the activation of the reminder action and the contents of the indirect information may be controlled with reference to the evaluation on the user A of the user B, who is an activation target of the reminder action, and the evaluation on each episode of the user B.

How a memory remains varies from person to person, such as leaving an impression due to an influence by surrounding information, leaving an impression due to special circumstances of going to the shop, or leaving an impression due to bad, delicious, or super delicious. The evaluation as described above may be set on the basis of various criteria corresponding to each user.

### Example of Indirect Information

Although information that triggers recollection of another person is presented as the indirect information, other information may be presented as the indirect information as long as there is a possibility that the information triggers communication between two persons.

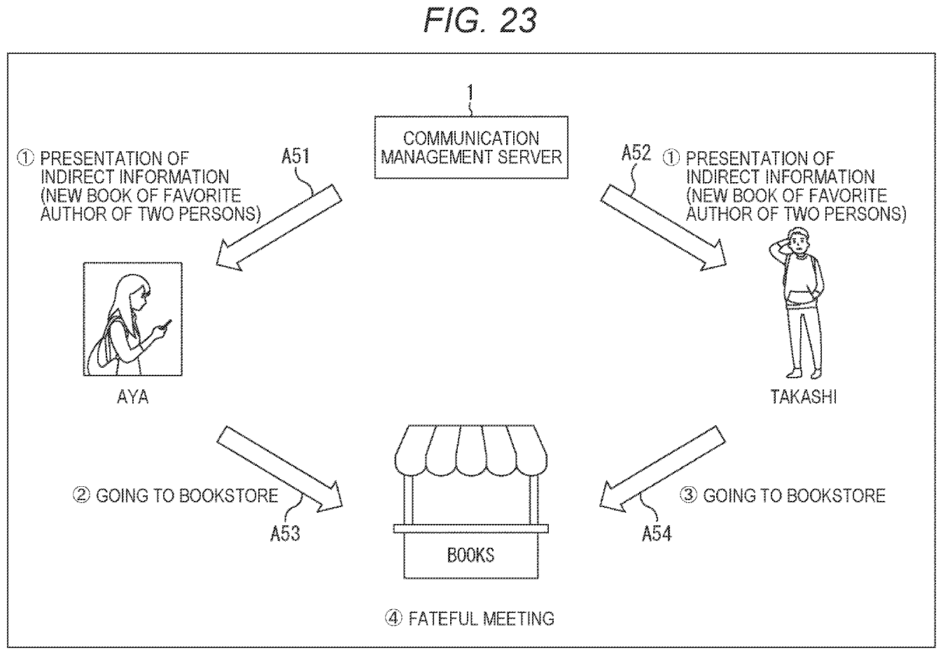

FIG. 23 is a view illustrating an example of presentation of indirect information.

In response to activation of the reminder action, indirect information is presented to each of the user A and the user B as indicated by arrows A51 and A52. The indirect information presented in FIG. 23 is information regarding release of a new book of a favorite author of the two persons.

The user A who has seen the indirect information goes to a bookstore as indicated by arrow A53. The user B who has seen the indirect information also goes to the bookstore as indicated by arrow A54. The two persons will meet in the bookstore.

In this manner, information intended to guide to a certain place may be presented as the indirect information. The indirect information as illustrated in FIG. 23 may be presented when the two persons are near the bookstore. The fact that the two persons are near the bookstore is specified on the basis of position information of client terminals used by the two persons. As described above, the client terminal is equipped with a positioning sensor such as a GPS sensor.

A place such as a bookstore to which the two persons are guided may be selected on the basis of action histories of the two persons. For example, information intended to guide to a place where the two persons often go is presented to the two persons as the indirect information.

As the information intended to guide to a certain place, various types of information may be used such as information about an event held in a certain place and information about dishes that can be eaten in a certain shop.

### Selection Example of Indirect Information

Although the indirect information is selected on the basis of a keyword regarding an episode, the indirect information may be selected on the basis of other information common with other users.

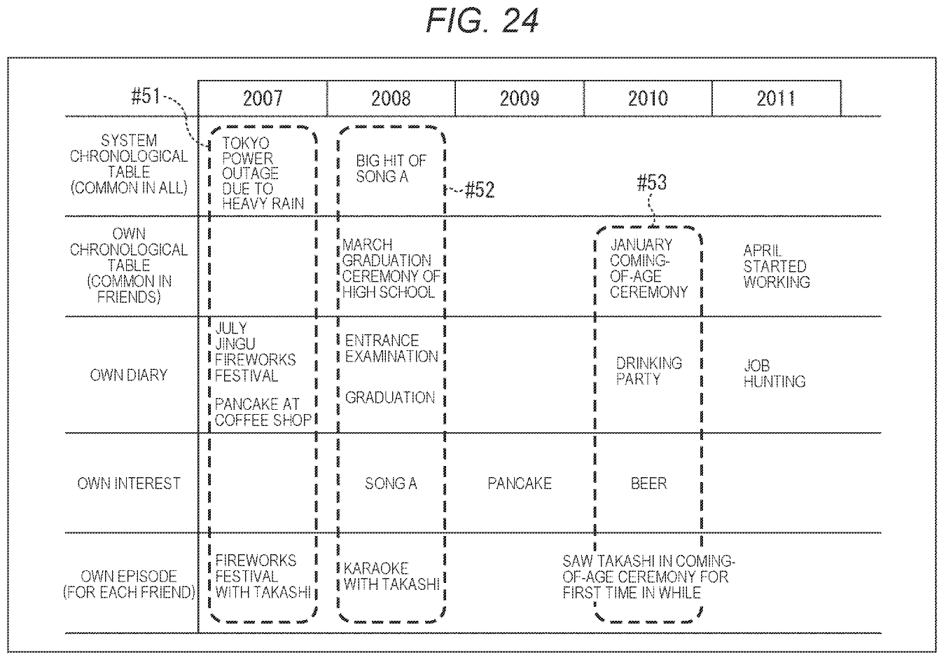

FIG. 24 is a view illustrating an example of information used for selection of indirect information.

As illustrated in FIG. 24, each piece of information of a system chronological table, an own chronological table, an own diary, an own interest, and an own episode is used for selection of indirect information. The information illustrated in FIG. 24 is information related to the user A.

The information of the system chronological table is information regarding events in the world that are common in all users of the communication system. Information such as weather, an incident, an accident, a trend, a movie, and a song is information of the system chronological table.

The information of the own chronological table is information regarding events at each age of the user. The information of the own chronological table such as an event at a school is information in common with other users of the same age.

The information of the system chronological table and the information of the own chronological table are automatically managed in the communication system with linkage to, for example, information such as a date (year/month/day) of occurrence of the event. The information of the own diary and information of interests and preferences, which are information regarding events of the user, are also managed with linkage to information such as a date.

Furthermore, in the communication system, events and the like in the same time of year are managed with linkage to episodes. In the example of FIG. 24, as indicated by being surrounded by a broken line #51, “Tokyo power outage due to heavy rain” which is the information of the system chronological table of 2007, “Jingu fireworks festival in July” and “pancake at coffee shop” which are the information of the own diary in 2007, and “fireworks festival with Takashi” which is an episode with Takashi in 2007 are managed with linkage to each other. In this manner, for example, events of the same year are managed with linkage to each other.

The information of 2008 surrounded by a broken line #52 and the information of 2010 surrounded by a broken line #53 are also managed with linkage to each other. Such information of the same time of year is linked to related events that have occurred later.

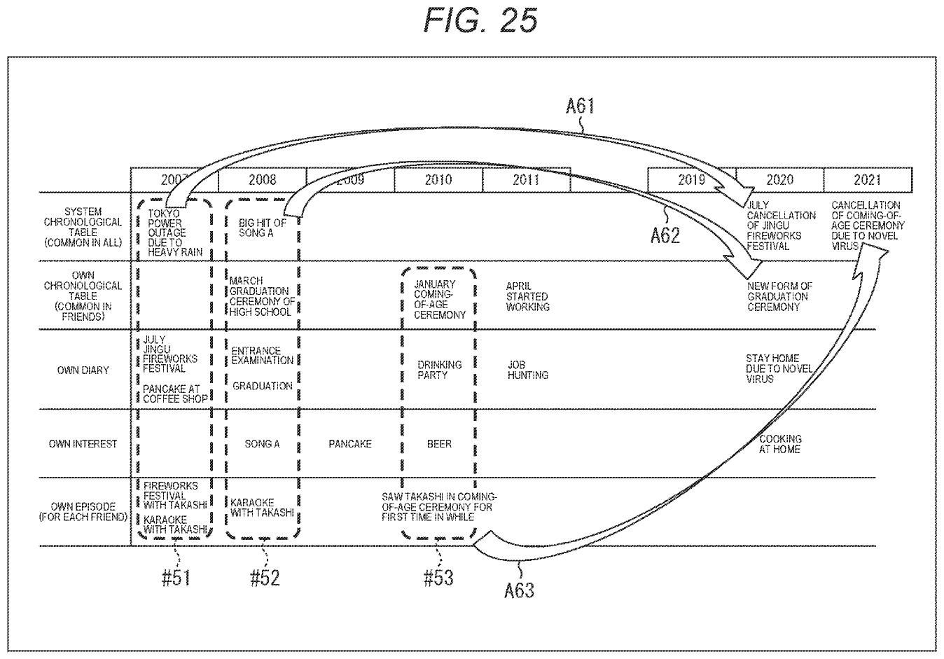

FIG. 25 is a view illustrating an example of linkage of events.

For example, in a case where “cancellation of Jingu fireworks festival in July” is registered as the information of the system chronological table of 2020 (the current time is July 2020), the information about “cancellation of Jingu fireworks festival in July” is linked to the information of 2007 including information about the same “Jingu fireworks festival” as indicated by an arrow A61. In a case where the reminder action for the user B has been activated, not only information such as an advertisement of “Jingu fireworks festival” related to the episode with the user B in 2007, but also information related to “heavy rain” and “power outage” linked to the information about “Jingu fireworks festival” is selected as the indirect information and presented to the user B.

For example, the user B who has watched the recent (July 2020) news regarding “heavy rain” and “power outage” recalls that there has been “heavy rain” in 2007 as well, and recalls that the user B has been to fireworks with Aya in the same time of year.

Furthermore, in a case where “new form of graduation ceremony” is registered as the information of the system chronological table of 2020 (the current time is July 2020), the information about “new form of graduation ceremony” is linked to information of 2008 including information about the same “graduation ceremony” as indicated by an arrow A62. In a case where the reminder action for the user B has been activated, not only information such as an advertisement of “karaoke” related to the episode with the user B in 2008, but also “song A” linked to the information about “karaoke” is selected as the indirect information and presented to the user B.

The user B who has listened to the reproduced “song A” recalls that “song A” has been popular in 2008, and recalls that the user B has been to karaoke with Aya in the same time of year.

Similarly, in a case where “cancellation of coming-of-age ceremony due to novel virus” is registered as the information of the system chronological table of 2021 (the current time is 2021), the information about “cancellation of coming-of-age ceremony due to novel virus” is linked to information of 2010 including information about the same “coming-of-age ceremony” as indicated by an arrow A63. In a case where the reminder action for the user B has been activated, information regarding “coming-of-age ceremony” is selected as the indirect information and presented to the user B on the basis of the episode with the user B in 2010.

The user B who has seen the information regarding “coming-of-age ceremony” recalls meeting Aya in “coming-of-age ceremony” in 2010.

In this manner, the indirect information may be selected on the basis of keywords regarding general events that have occurred in the same time of year as the event involved in the episode.

### <Example of Trigger for Presentation Start of Indirect Information>

In a case where the reminder action has been activated, various types of information can be used as a trigger for starting presentation of the indirect information. It is assumed that the episodes and the like described with reference to FIGS. 24 and 25 have been registered in the communication system.

Example in which being in Certain Time of Year is Used as Trigger

For example, in a case where the current season is summer, an advertisement of “Jingu fireworks festival”, news of “power outage”, and the like are presented on the basis of the information of 2007. Furthermore, in a case where the current time of year is the graduation season, “song A” is presented on the basis of the information of 2008. The presentation of these pieces of information is repeatedly performed, for example, several months before the event such as “Jingu fireworks festival” or “graduation ceremony”.

Example in which being at Certain Place is Used as Trigger

For example, in a case where the user B is near “Jingu”, an advertisement of “Jingu fireworks festival”, and the like, are presented on the basis of the information of 2007. Furthermore, in a case where the user B is near the high school from which the user B graduated, “song A” is presented on the basis of the information of 2008. A position of the user B is detected by a GPS sensor or the like of the client terminal of the user B, and is acquired by the communication system.

Example in which Certain Event is Used as Trigger

For example, in a case where a disaster occurs, news of “power outage”, an advertisement of “Jingu fireworks festival”, and the like are presented on the basis of the information of 2007.

As described above, various types of information can be used as a trigger for starting presentation of the indirect information.

### Modifications

### Example Indirect Information According to Reminder Degree

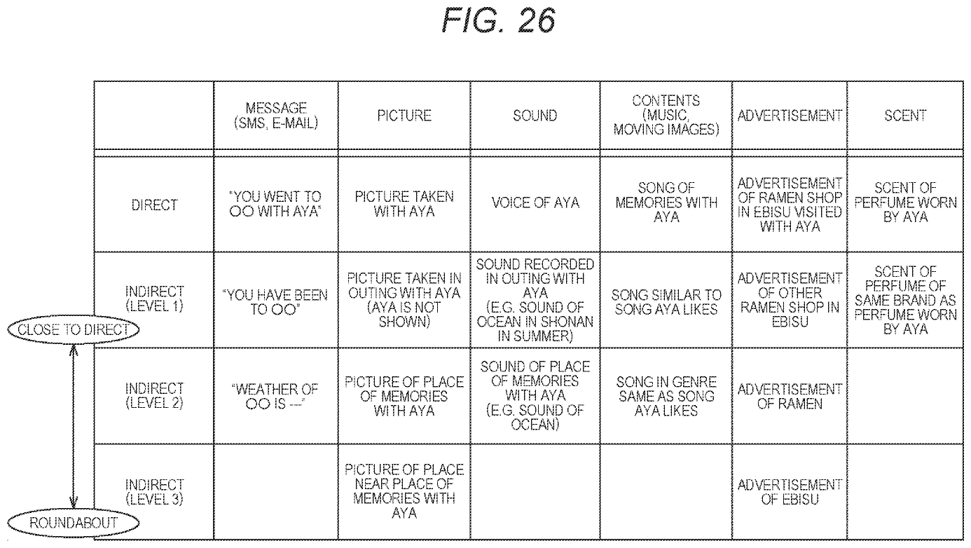

FIG. 26 is a view illustrating an example of indirect information.

Although the case where information such as messages, news, and advertisements is used as the indirect information has been mainly described, it is possible to use pictures, sound, contents, scent, and the like as illustrated in FIG. 26. The contents include moving images, music, and the like.

The presentation of sound as the indirect information is performed by causing the speaker 142 of the client terminal to output sound or the like. Furthermore, the presentation of the scent is performed by generating scent from a scent generation device that operates under the control of the client terminal.

A level indicating a reminder degree may be set for the indirect information. As the indirect information related to the same episode, a plurality of pieces of information according to the levels is prepared. In the example of FIG. 26, three levels of level 1 to 3 are set. The indirect information at a high level (indirect information close to level 1) is information close to the direct information.

In messages illustrated in FIG. 26, the message of “you went to oo with Aya” includes the name of “Aya” which is the user A, and is thus direct information. The message “you went to oo with Aya” is not presented to the user B. “oo” represents, for example, a sightseeing spot.

The message of “you have been to oo” and the message of “weather of oo is---” are indirect information selected on the basis of the episode of when the user went to “oo” with Aya. The former message does not include the name of “Aya”, but is a message reminding of having been to “oo” in the past, and thus is a message having a higher level than the latter message. The latter message is merely weather information of “oo”, and is information that is less likely to cause association of “Aya”.

Furthermore, in the picture illustrated in FIG. 26, a picture taken with “Aya” is direct information since “Aya” which is the user A is shown. The picture taken with “Aya” is not presented to the user B.

A picture in which “Aya” is not shown, such as a landscape taken in outing with “Aya”, a picture of a place of memories with “Aya” taken by a third person, and a picture of a place near a place of memories with “Aya” taken by a third person are indirect information selected on the basis of the episode of outing with “Aya”.

The picture in which “Aya” is not shown, such as a landscape taken in outing with “Aya” does not include “Aya”, but is a picture taken in outing with “Aya”. Therefore, the picture has a higher level than the picture of a place of memories with “Aya” taken by a third person. Furthermore, the picture of the place of memories with Aya taken by a third person has a higher level than the picture of a place near the place. As the level of the picture is higher, “Aya” is easily associated from the information.

Which level of indirect information is used for presentation is determined on the basis of the evaluation of the user A and the evaluation of the user B described above. For example, as the evaluation of the user A for the user B is higher or the evaluation of the user B for the user A is higher, indirect information of a higher level is presented to the user B.

The possibility that the user B will recall the user A is controlled by changing the indirect information presented to the user B.

Which level of indirect information is used for presentation may be selected on the basis of the operation level (FIG. 6) set when the reminder action is activated. The operation level is set, for example, in accordance with strength of a feeling of the user A who is thinking of the user B. The strength of a feeling is specified by analyzing an input content of the user A or analyzing an action of the user A. Furthermore, the strength of a feeling is specified by analyzing biological reaction of the user A when thinking of the user B.

As the feeling for the user B is stronger, the presentation to the user B is performed using the indirect information of a higher level. As a result, it becomes possible to cause the user B to easily recall the user A.

The level of the indirect information to be presented to the user B may be specified by the user A.

In a case of repeatedly performing the presentation of the indirect information selected on the basis of the same episode, the level of the indirect information may be gradually increased. Furthermore, the episode may be varied and the indirect information may be selected on the basis of keywords relating to different episodes.

For example, in a case of using the indirect information of the picture in FIG. 26, a picture at level 3 is presented as the first indirect information. In a case where the user B does not contact the user A even after the presentation of the first indirect information, a picture of level 2 is presented as the second indirect information. In a case where the user B does not contact the user A even after the presentation of the second indirect information, a picture of level 1 is presented as the third indirect information.

In a case where the user B recalls the user A after seeing the picture of level 1, it is more intrusive for the user B than in a case where the user B recalls the user A after seeing the picture of level 2 or level 3 lower than the picture of level 1. By presenting the indirect information having a low level first, it is possible to remind of the user A in a more natural manner.

Furthermore, as described with reference to FIG. 19, the user A may determine which episode is used as a base of the indirect information to be presented.

A function of designating the level of the indirect information and the episode may be made available only to a user who has paid a predetermined fee. The user A can intentionally remind the user B of the user A by specifying the indirect information of a high level or specifying the indirect information selected on the basis of an episode that has left a strong impression on the user B.

### Other Examples

The user B may be able to input that the user A is recalled in a case where the user B recalls the user A after seeing the indirect information. On a screen of the communication application, a button to be pressed when someone is recalled is displayed together with the indirect information.

In the communication management server 1, what kind of information is used as the indirect information to be more effective for the user B, how the indirect information is presented to be more effective for the user B, and the like are learned according to the input of the user B. Since the indirect information is presented to the user B on the basis of a learning result, it is possible to effectively present the indirect information.

### Example of Program

The above-described series of processing may be executed by hardware or may be executed by software. In a case where the series of processing is executed by software, a program constituting the software is installed to a computer incorporated in dedicated hardware, a general-purpose personal computer, or the like.

The program to be installed is provided by being recorded in a removable medium 21 illustrated in FIG. 9, including an optical disc (compact disc-read only memory (CD-ROM), a digital versatile disc (DVD), and the like), a semiconductor memory, or the like. Furthermore, the program may be provided via a wired or wireless transmission medium such as a local area network, the Internet, or digital broadcasting. The program can be installed in advance in the ROM 12 or the storage unit 18.

The program executed by the computer may be a program in which the processes are performed in time series in the order described in the present description, or may be a program in which the processes are performed in parallel or at a necessary timing such as when a call is made.

In the present specification, a system is intended to mean a set of a plurality of components (devices, modules (parts), and the like), and it does not matter whether or not all the components are in the same housing. Therefore, a plurality of apparatuses accommodated in separate housings and connected via a network and one apparatus in which a plurality of modules is accommodated in one housing are both systems.

The effects described in the present description are merely examples and are not restrictive, and additionally, other effects may be provided.

Embodiments of the present technology are not limited to the above-described embodiment, and various modifications may be made without departing from the gist of the present technology.

For example, the present technology can have a cloud computing configuration in which one function is shared and processed in cooperation by a plurality of devices via a network.

Furthermore, each of the steps described in the above-described flowcharts can be executed by one device or executed by a plurality of devices in a shared manner.

Moreover, in a case where a plurality of processing is included in one step, the plurality of processing included in the one step can be executed by one device or executed by a plurality of devices in a shared manner.

### Examples of Combinations of Configurations

The present technology may also have the following configurations.

(1)

An information processing apparatus including:
a detection unit configured to detect an action of a user estimated as thinking of another user; and
a presentation unit configured to present information related to an episode between the user and the another user to the another user together with other information not related to the episode, in a case where an action of the user estimated as thinking of the another user is detected.

(2)

The information processing apparatus according to (1) above, in which
the presentation unit presents information not including information about the user, as information related to the episode.

(3)

The information processing apparatus according to (1) or (2) above, in which
the presentation unit presents information selected on the basis of a content of the episode.

(4)

The information processing apparatus according to (3) above, in which
the information selected on the basis of a content of the episode is information regarding an event after a timing at which an event involved in the episode has occurred.

(5)

The information processing apparatus according to any one of (1) to (4) above, further including:
a storage unit configured to store information about the episode between with each of a plurality of the another users who are acquaintances of the user, in which
the presentation unit presents information related to the episode between the user and a specific another user of which the user is thinking, among the another users.

(6)

The information processing apparatus according to any one of (1) to (5) above, in which
the presentation unit presents information related to the episode to the another user who is an acquaintance to which a predetermined evaluation is set for the user.

(7)

The information processing apparatus according to any one of (1) to (6) above, in which
the presentation unit presents information related to the episode in a case where a predetermined evaluation has been set as an evaluation of the another user for the user.

(8)

The information processing apparatus according to (7) above, in which
the presentation unit presents information related to the episode for which a predetermined evaluation has been set as an evaluation of the another user, among the episodes between the user and the another user.

(9)

The information processing apparatus according to any one of (1) to (8) above, in which
the presentation unit repeatedly presents information related to the episode.

(10)

The information processing apparatus according to (9) above, in which
the presentation unit changes the episode that is a base of information to be presented, and presents information related to the episode.

(11)

The information processing apparatus according to (9) or (10) above, in which
the presentation unit gradually increase a degree of indicating the user, and repeats presentation of information related to the episode.

(12)

The information processing apparatus according to any one of (1) to (11) above, in which
the presentation unit presents a plurality of pieces of information individually related to a plurality of the episodes at a same timing.

(13)

The information processing apparatus according to any one of (1) to (12) above, in which
the detection unit detects an action of the user estimated as thinking of the another user, on the basis of at least any of a content input by the user or a situation of the user.

(14)

The information processing apparatus according to any one of (1) to (13) above, in which
the presentation unit presents information related to the episode also to the user.

(15)

The information processing apparatus according to (14) above, in which
the presentation unit presents information related to the episode that is same or information related to the episode that is different, to each of the user and the another user.

(16)

The information processing apparatus according to (15) above, in which
the presentation unit presents information related to a same place to each of the user and the another user.

(17)

The information processing apparatus according to (15) or (16) above, in which
the presentation unit presents information related to the same place on the basis of an action of each of the user and the another user.

(18)

The information processing apparatus according to any one of (1) to (17) above, in which
the presentation unit starts presentation of information related to the episode at a timing when a predetermined period has elapsed from a timing at which the user has thought of the another user.

(19)

An information processing method including,
by an information processing apparatus:
detecting an action of a user estimated as thinking of another user; and
presenting information related to an episode between the user and the another user to the another user, together with other information not related to the episode.

(20)

A program for causing a computer to execute processing including:
detecting an action of a user estimated as thinking of another user; and
presenting information related to an episode between the user and the another user to the another user, together with other information not related to the episode.

### REFERENCE SIGNS LIST

1 Communication management server
51 Information processing unit
61 Episode acquisition unit
62 Life log DB
63 Context detection unit
64 Indirect information presentation unit
101 Client terminal
151 Information processing unit
161 User operation detection unit
162 Sensor data acquisition unit
163 Display control unit

1. An information processing apparatus comprising:
a detection unit configured to detect an action of a user estimated as thinking of another user; and
a presentation unit configured to present information related to an episode between the user and the another user to the another user together with other information not related to the episode, in a case where an action of the user estimated as thinking of the another user is detected.

2. The information processing apparatus according to claim 1, wherein
the presentation unit presents information not including information about the user, as information related to the episode.

3. The information processing apparatus according to claim 1, wherein
the presentation unit presents information selected on a basis of a content of the episode.

4. The information processing apparatus according to claim 3, wherein
the information selected on a basis of a content of the episode is information regarding an event after a timing at which an event involved in the episode has occurred.

5. The information processing apparatus according to claim 1, further comprising:
a storage unit configured to store information about the episode between with each of a plurality of the another users who are acquaintances of the user, wherein
the presentation unit presents information related to the episode between the user and a specific another user of which the user is thinking, among the another users.

6. The information processing apparatus according to claim 5, wherein
the presentation unit presents information related to the episode to the another user who is an acquaintance to which a predetermined evaluation is set for the user.

7. The information processing apparatus according to claim 6, wherein
the presentation unit presents information related to the episode in a case where a predetermined evaluation has been set as an evaluation of the another user for the user.

8. The information processing apparatus according to claim 7, wherein
the presentation unit presents information related to the episode for which a predetermined evaluation has been set as an evaluation of the another user, among the episodes between the user and the another user.

9. The information processing apparatus according to claim 1, wherein
the presentation unit repeatedly presents information related to the episode.

10. The information processing apparatus according to claim 9, wherein
the presentation unit changes the episode that is a base of information to be presented, and presents information related to the episode.

11. The information processing apparatus according to claim 9, wherein
the presentation unit gradually increase a degree of indicating the user, and repeats presentation of information related to the episode.

12. The information processing apparatus according to claim 1, wherein
the presentation unit presents a plurality of pieces of information individually related to a plurality of the episodes at a same timing.

13. The information processing apparatus according to claim 1, wherein
the detection unit detects an action of the user estimated as thinking of the another user, on a basis of at least any of a content input by the user or a situation of the user.

14. The information processing apparatus according to claim 1, wherein
the presentation unit presents information related to the episode also to the user.

15. The information processing apparatus according to claim 14, wherein
the presentation unit presents information related to the episode that is same or information related to the episode that is different, to each of the user and the another user.

16. The information processing apparatus according to claim 15, wherein
the presentation unit presents information related to a same place to each of the user and the another user.

17. The information processing apparatus according to claim 15, wherein
the presentation unit presents information related to the same place on a basis of an action of each of the user and the another user.

18. The information processing apparatus according to claim 1, wherein
the presentation unit starts presentation of information related to the episode at a timing when a predetermined period has elapsed from a timing at which the user has thought of the another user.

19. An information processing method comprising,
by an information processing apparatus:
detecting an action of a user estimated as thinking of another user; and
presenting information related to an episode between the user and the another user to the another user, together with other information not related to the episode.

20. A program for causing a computer to execute processing comprising:
detecting an action of a user estimated as thinking of another user; and
presenting information related to an episode between the user and the another user to the another user, together with other information not related to the episode.
